(19) United States
(12) Patent Application Publication
(10) Pub. No.: US 2012/0303422 A1
(43) Pub. Date: Nov. 29, 2012

(54) Computer-Implemented Systems And Methods For Ranking Results Based On Voting And Filtering

(76) Inventors: Diran Li, Montreal (CA); Wesley Tanaka, Honolulu, HI (US)

(21) Appl. No.: 13/117,949

(22) Filed: May 27, 2011

(51) Int. Cl. G06Q 30/00

(52) U.S. Cl. 705/12

(57) ABSTRACT

Systems and methods are provided for filtering a pool of image designs. Votes for a plurality of image designs are received, the votes forming a distribution across the pool of image designs. A mean, a confidence interval, and a minimum are determined for the distribution based on the plurality of votes. A determination is made as to whether a break-point threshold has been reached for the pool of image designs, where the break-point threshold is based on the mean, the confidence interval, and the minimum. A further determination is made as to whether each particular design should be removed from consideration after the break-point threshold has been met, where a particular design is removed from consideration based on a mean of votes for the particular design and a confidence interval for the particular design. Image designs that have not been removed from consideration are then given preferential treatment when selecting the images to display.

### FIELD

The technology described herein relates generally to design voting and more specifically to focused voting through adaptive filtering.

### BACKGROUND

Traditional providers of graphic design products (e.g., greeting cards, business cards, flyers, brochures) offer a limited number of designs generated by in-house creators or paid third-party contractors. Limited customizations may be available for these design products, such as the incorporation of a corporate logo onto business cards or the inclusion of a photograph onto a greeting card. While the designs provided may be appropriate for many applications and occasions, the limited number of parties having creative input may result in a too-rigid environment that does not offer sufficient options for conveying certain messages.

Thus, there is a need for a graphics design system that offers consumers the capability to create and customize graphic designs according to their communications needs. There is also a need for a system where those consumer-created designs can be shared among the population of consumers, thus increasing the creative talent pool for graphic design.

### SUMMARY

Systems and methods are provided for filtering a pool of image designs. In one example, votes for a plurality of image designs are received, where the votes form a distribution across the pool of image designs. A mean, a confidence interval, and a minimum are determined for the distribution based on the plurality of votes. A determination is made as to whether a break-point threshold has been reached for the pool of image designs, where the break-point threshold is based on the mean, the confidence interval, and the minimum. A further determination is made as to whether each particular design should be removed from consideration after the break-point threshold has been met, where a particular design is removed from consideration based on a mean of votes for the particular design and a confidence interval for the particular design. Image designs that have not been removed from consideration are then given special prominence when displayed to voters. For example, designs that have not been removed from consideration can be displayed earlier in an otherwise randomly ordered sequence of images presented to a voter.

As another example, a system for filtering a pool of image designs may include one or more data processors and a computer-readable medium encoded with instructions for commanding the one or more data processors to execute a method. In the method, votes for a plurality of image designs are received, where the votes form a distribution across the pool of image designs. A mean, a confidence interval, and a minimum are determined for the distribution based on the plurality of votes. A determination is made as to whether a break-point threshold has been reached for the pool of image designs, where the break-point threshold is based on the mean, the confidence interval, and the minimum. A further determination is made as to whether each particular design should be removed from consideration after the break-point threshold has been met, where a particular design is removed from consideration based on a mean of votes for the particular design and a confidence interval for the particular design. Image designs that have not been removed from consideration are then given special prominence when displayed to voters. For example, designs that have not been removed from consideration can be displayed earlier in an otherwise randomly ordered sequence of images presented to a voter.

As a further example, a computer-readable medium may be encoded with instructions for commanding one or more data processors to execute a method for filtering a pool of image designs. In the method, votes for a plurality of image designs are received, where the votes form a distribution across the pool of image designs. A mean, a confidence interval, and a minimum are determined for the distribution based on the plurality of votes. A determination is made as to whether a break-point threshold has been reached for the pool of image designs, where the break-point threshold is based on the mean, the confidence interval, and the minimum. A further determination is made as to whether a particular design should be removed from consideration after the break-point threshold has been met, where the particular design is removed from consideration based on a mean of votes for the particular design and a confidence interval for the particular design. Image designs that have not been removed from consideration are then given special prominence when displayed to voters. For example, designs that have not been removed from consideration can be displayed earlier in an otherwise randomly ordered sequence of images presented to a voter.

### BRIEF DESCRIPTION OF THE DRAWINGS

FIG. 1 is a block diagram depicting an example voting candidate filter manager.

FIG. 2 is a block diagram depicting a voting application providing a list of ranked voting candidates.

FIG. 3 is a block diagram depicting filtering of voting candidates for consideration.

FIG. 4 is a time line depicting example voting phases.

FIG. 5 is a graph depicting a transition from a data gathering time period to a data filtering time period based on a mean of the distribution across all candidates.

FIG. 6 is a flow diagram depicting an example method for filtering a pool of image designs.

FIG. 7 is a flow diagram depicting another example method for filtering a pool of image designs.

FIG. 8 depicts an example graphical user interface for ignoring certain voters.

FIGS. 9A, 9B, and 9C depict example systems for use in implementing a voting candidate filter manager.

### DETAILED DESCRIPTION

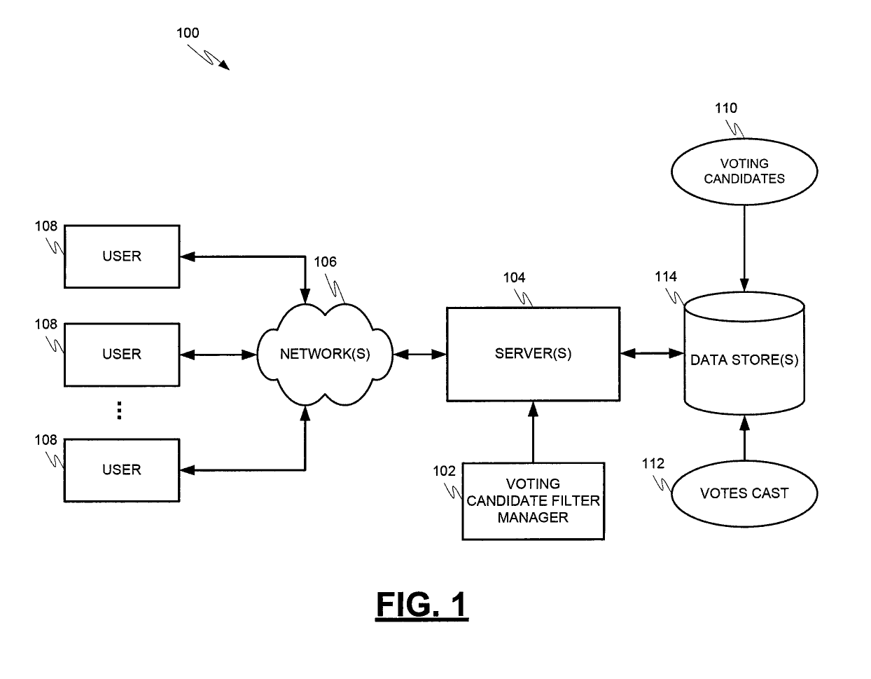

FIG. 1 is a block diagram depicting an example voting candidate filter manager. The voting candidate filter manager 102 manages the display and vote tabulation of a plurality of voting options. For example, a voting candidate filter manager may be utilized in managing voting for a top-20 image design template competition. In such a competition, a number of image design templates are provided to a voting populous, such as via the Internet. Votes are received and tabulated, and a ranking is generated. Such a ranking may be provided to a variety of parties such as consumers of the website. The top-20 image design templates may be displayed according to their ranking for purchase by the consumers. The consumers may personalize the templates with pictures and text and purchase high-quality printings based on their customized templates (e.g., invitations, posters, stationary, cards, calendars, book covers, business cards, photo books).

A voting candidate filter manager 102 may be used to facilitate a wide variety of other types of voting applications as well. For example, a voting candidate filter manager 102 may be used to manage a political office election, a barbeque rib cook-off, a sports player-of-the-game competition, an acting award election, a top 40 songs of the week competition, as well as other applications.

A voting candidate filter manager 102 may be implemented using one or more servers 104 that are responsive to one or more networks 106 in providing an interface to users 108. Users 108 may be randomly provided one or more voting candidates 110 for consideration. A user 108 may vote for a voting candidate 110 or may rate a voting candidate (e.g., on a scale of 1 to 10, on a scale of 1 star to 5 stars). Voting candidates 110 as well as a record of votes cast 112 may be stored in one or more data stores 114 that are responsive to the one or more servers 104.

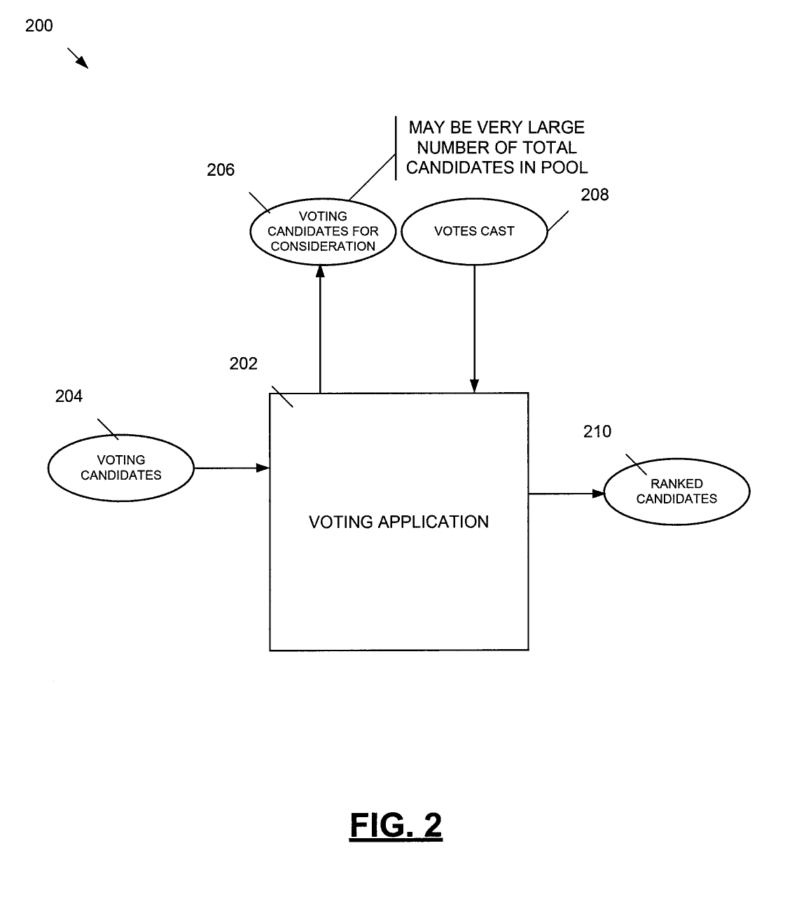

FIG. 2 is a block diagram depicting a voting application providing a list of ranked voting candidates. The voting application 202 receives a number of voting candidates 204 for consideration by a population of voters. The voting application 202 provides the voting candidates for consideration 206 to the population of voters. In some implementations, the number of voting candidates for consideration 206 may be very large. For example, in an implementation where user-submitted image design templates are submitted for voting to create a top-20 ranking, the number of image design templates initially submitted for consideration may be very significant. The voting application 202 receives a number of votes cast 208 for the displayed candidates 206, and generates a list of the candidates 210 that is ranked according to the received votes cast 208. In some implementations, voters are limited in the number of votes that they can cast in total and the number of votes that they can cast for an individual image design template. In other implementations, voters are unrestrained in their ability to vote.

The configuration of FIG. 2 may be sub-optimal in certain implementations. For example, in a voting competition to generate a top-20 list, after a certain period, it may become clear than certain of the voting candidates being displayed 206 will not end up in the resulting top-20. However, in the configuration of FIG. 2, which randomly provides candidates for consideration 206 from the pool of submitted candidates 204, these low performing candidates are still displayed for consideration by users. Because time available to users for voting is sometimes limited, time spent by users in considering candidates which are highly unlikely to make the top-20 may be time poorly spent. It would instead be better to have those users spend their voting time considering voting candidates having a higher likelihood of making the top-20.

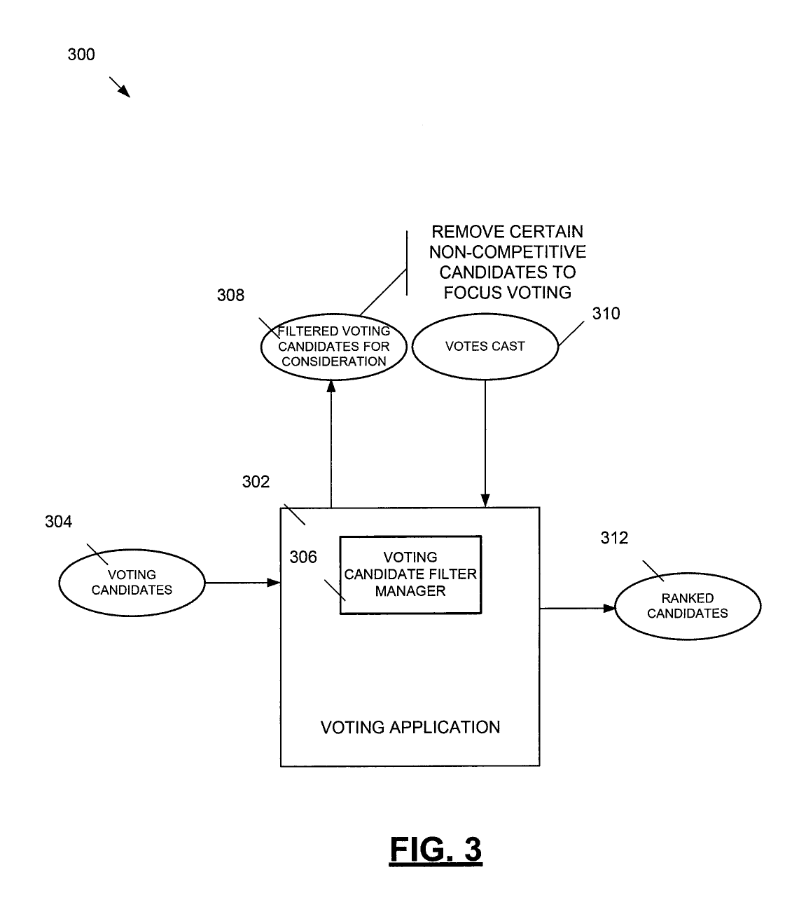

FIG. 3 is a block diagram depicting filtering of voting candidates for consideration. A voting application 302 receives a number of voting candidates 304 for consideration. A voting candidate filter manager 306 aids in providing candidates 308 for display to and consideration by users. The provided candidates 308 may include all of the voting candidates 304 or may be a filtered subset of the voting candidates 304. For example, the set of voting candidates 304 may be filtered to remove certain non-competitive candidates to provide a more focused set of candidates 308 for user consideration. Votes cast 310 are received by the voting application 302, and the received votes 310 are used to generate a set of ranked candidates 312, which may be provided for consideration.

In another example, instead of completely removing non-competitive candidates, candidates identified as being non-competitive may have their probability of being provided for display and consideration lessened. This reduction in display probability may be proportional to a level of non-competitiveness of the candidate (e.g., designs below but near the non-competitive threshold may have their probability of display reduced 25%, while a design far below the threshold may have a more significant reduction in display probability).

The implementation of FIG. 3 provides a more focused set of candidates 308 for user consideration based on filtering of the provided set of voting candidates. However, it may be desirable to include safeguards to protect against certain candidates being removed from consideration prematurely. For example, a candidate that may well be one of the top-20 preferred candidates may perform poorly during an initial voting period. If that candidate was removed based on the poor initial performance, then that candidate would not be present in the final ranked list of candidates. Thus, it may be desirable that a statistically significant number of votes be received or other criteria be met before certain candidates are removed from consideration.

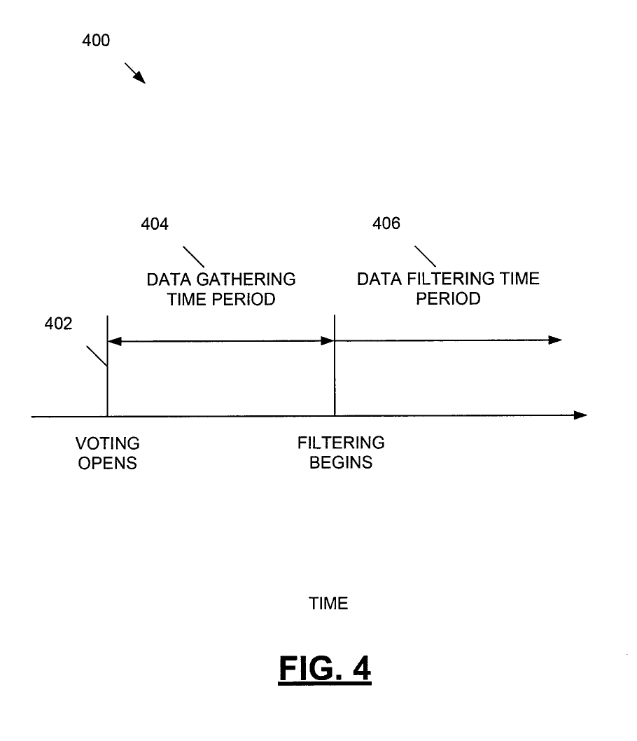

FIG. 4 is a time line depicting example voting phases. Voting for a plurality of candidates opens at 402. To avoid premature removal of candidates from consideration, a first time period is a data gathering time period 404. During the data gathering time period 404, all provided candidates may be randomly provided to users for consideration and voting. No candidates are removed from consideration during the data gathering period. The data gathering period 404 helps to ensure that a significant number of votes are collected so that candidates are not prematurely removed from consideration, which could result in anomalous results.

A candidate that may ultimately be successful may perform poorly initially for a number of reasons. For example, in a voting competition for a top-20 image design template list, an image design template creator may be awarded a monetary commission or be otherwise compensated (e.g., awarded a prize) in exchange for consumers purchasing the creator's image design template (e.g., to create cards, business cares, posters, invitations). Consumers may tend to select image design templates from the top-20 list much more often than from other image design template categorizations. Thus, garnering a top-20 list spot may be quite lucrative to an image design template creator. This monetary incentive may encourage image design template creators and their associates to “stuff the ballot box” in voting for the creator's templates and voting against other templates. If certain safeguards are not in place, initial spikes in voting averages created by such incentivized voting may place less desirable designs in the top-20 while more desirable designs are removed from consideration based on their initial poor performance.

Voting progress is monitored, and once a sufficient number of votes are received, a data filtering time period begins. During the data filtering time period 406, candidates are periodically or continually removed from consideration based on poor performance. Such poor performance is measured statistically, such that it is determined with a level of certainty that the removed candidate will not be successful (e.g., in making the top-20 list).

The identification of when the data filtering period 406 should begin may be made in a variety of ways. For example, the data filtering period 406 may begin when received voting reaches a break-point threshold. A break-point threshold may be determined as a point in the voting when a statistically significant amount of voting data has been gathered, such that decisions about the viability of certain voting candidates may be made.

In one example, the break-point threshold may be based on characteristics of a distribution of votes across a pool of provided voting candidates. For example, the break-point threshold may be set based on a lower bound mean a such that mean(X)>α for X={X₁, . . . , Xₙ}, and lower bound interval width β such that β<size(CI), where α is the mean for the distribution threshold and β is the confidence interval threshold, wherein mean(X) is the mean for the distribution and size(CI) is the confidence interval for the distribution. As more votes are received during the data gathering phase, the mean of the distribution will increase until it reaches α. At that point, if the confidence interval around the mean has a size smaller than β, then the break-point threshold has been reached and the process moves to the data filtering phase. If not, then the data collection phase continues until the mean has reached the upper bound of the confidence interval

$$α + \frac{size ( CI at α )}{2}$$

or the minimum number of votes has reached an ultimate break-point, Ω. The ultimate break-point, Ω, may be utilized to trigger the data filtering phase in a case of high data variability, such as variability caused by voting based on favoritism. In one example, α, β, and Ω are set at α=50, β=15, and Ω=75.

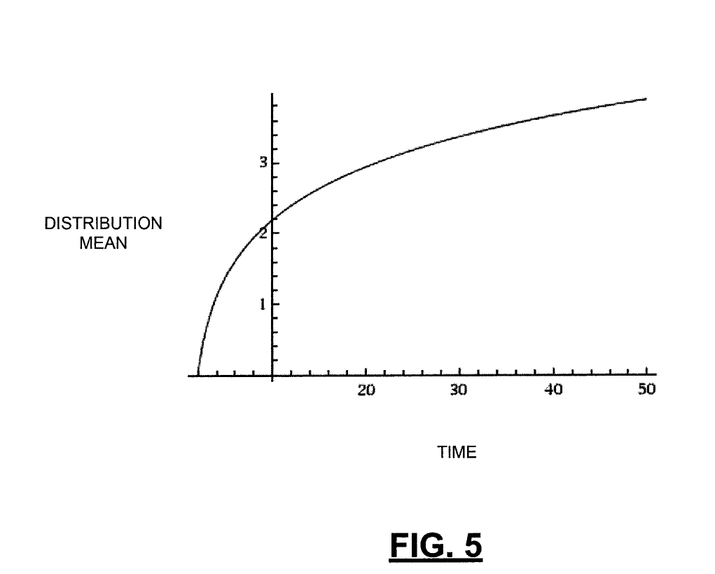

FIG. 5 is a graph depicting a transition from a data gathering time period to a data filtering time period based on a mean of the distribution across all candidates. In FIG. 5, as voting data is aggregated over time, the mean of the distribution of the voting data across all candidates increases. At time equals ten, the α threshold for the mean of the distribution is reached. If the confidence interval of the mean is within the β width, then the process transitions to the data filtering period.

Once the break-point threshold has been reached, the algorithm may begin registering the confidence interval associated with each candidate to provide filtering. Following filtering, remaining candidates are ranked. Remaining candidates may be presented to users for additional voting, where further filtering may be performed after additional votes are received.

In one example, candidates are removed from consideration based on a mean of votes for the particular design and a confidence interval for the particular design. Specifically, filtering may be performed incrementally. Given a total number of candidates, n, and a number of rounds of filtering performed thus far (or an amount of time since voting has started), i, a preliminary minimum number of candidates to retain may be calculated according to γᵢ=n−50×(i+1). An additional floor value, Γ, may also be considered, such that a minimum number of candidates to retain is the greater of γᵢ and Γ for all rounds i (i.e., min{γᵢ|∀i>0}≧Γ).

With a continued inflow of voting data, the variability around the mean of each design tends to decrease, which in terms of confidence intervals, translates into the narrowing of the interval width. As the interval width decreases for single intervals, the distance between confidence intervals for different candidates tends to increase as designs differentiate from one another. In one example, a marginalized poor design will be discarded when the mean for that design is lower than the mean of the top δᵢ designs and the confidence interval of that design has no overlap with any confidence intervals of the top δᵢ designs. Practically, assuming the current working set is n₀ and the threshold is δᵢ_{₀}, as voting data is received and the confidence intervals become narrower, there will be designs for which the interval is smaller than and not overlapping with the top δᵢ_{₀} number of designs. When this happens, those low performing designs are removed from consideration. In one example, δᵢ might be calculated as δᵢ=γᵢ. In another example, δᵢ might be set to some constant like δᵢ=1.

The process may be repeated as more voting data is received until γᵢ=Γ. When Γ has been reached, all further filtering may be ceased. The Γ value guarantees that the final set of candidates provided to users for voting has at least a certain number of candidates.

In one example, confidence intervals may be calculated as follows. Assuming the distributions of all voters are independent and identically distributed, the Central Limit Theorem may be applied, with values normalized, where the 95% confidence interval is subsequently calculated. Given a data set with X={X₁, . . . , Xₙ} data points pooling independent and identically distributed random variables with mean E(Xᵢ)=μ, variance Var(Xᵢ)=σ², and standard deviation std(Xᵢ)=σ, estimate the mean and standard deviation with E(X)=\hat{μ}=

$$\frac{1}{n} {\sum }_{i = 1}^{n} {X}_{i} and std ( X ) = \frac{σ}{\sqrt{n}} .$$

Normalizing with

$$Z = \frac{\hat{μ} - μ}{σ / \sqrt{n}} ,$$

where μ is the mean whose prediction is sought, the 95% confidence interval can then be calculated as P(|Z|<z)=0.95, given the normal assumption, z=1.96. The confidence interval is then calculated according to:

$$( - z < \frac{\hat{μ} - μ}{σ / \sqrt{n}} < z ) = ( \hat{μ} - z \cdot \frac{σ}{\sqrt{n}} < μ < \hat{μ} + z \cdot \frac{σ}{\sqrt{n}} )$$

resulting in the

$$( \hat{μ} - z \cdot \frac{σ}{\sqrt{n}} , \hat{μ} + z \cdot \frac{σ}{\sqrt{n}} )$$

interval.

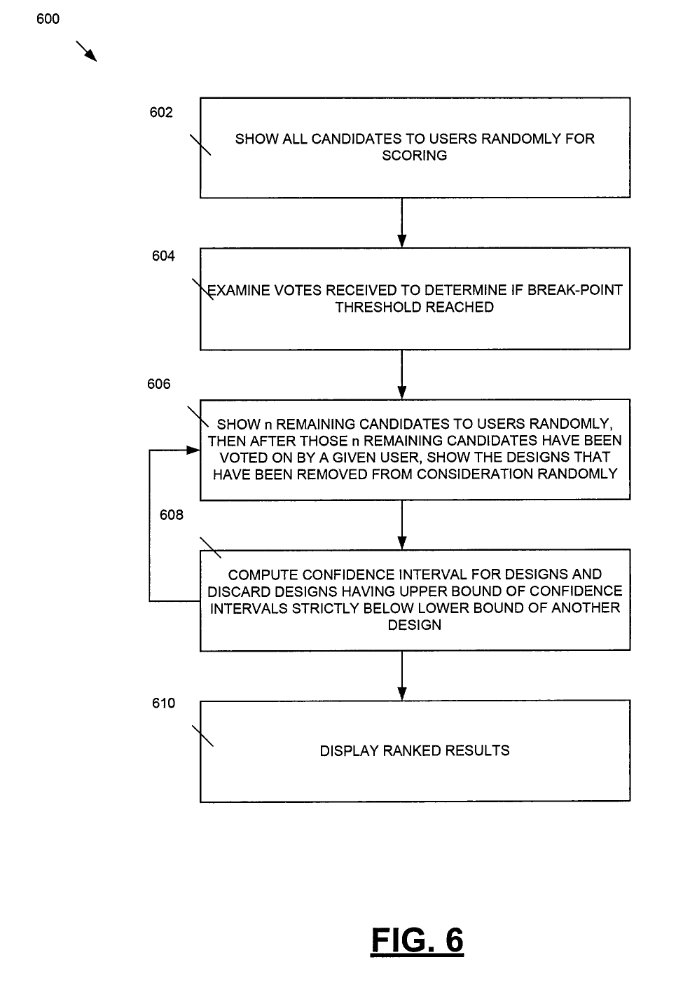

FIG. 6 is a flow diagram depicting an example method for filtering a pool of image designs. At 602, all candidates are randomly shown to users for scoring. The votes received are examined at 604 to determine if the break-point threshold has been reached. At 606, remaining candidates are shown to users randomly for additional voting preferentially over other candidates that have been removed from consideration. If filtering has not yet begun because the break-point threshold has not been reached, then the n remaining candidates will contain the full set of candidates. At 608, confidence intervals are calculated for individual designs, when the process has moved to the filtering time period. Designs whose confidence intervals are entirely below the lower bound of the confidence interval of a cutoff design are removed from consideration. The ranked results may be displayed at 610, and the process may additionally revert to 606 where remaining candidates are provided to users for additional voting. In one embodiment, designs whose confidence intervals are entirely within a bottom fraction are not completely removed from consideration, but are shown less frequently at 606.

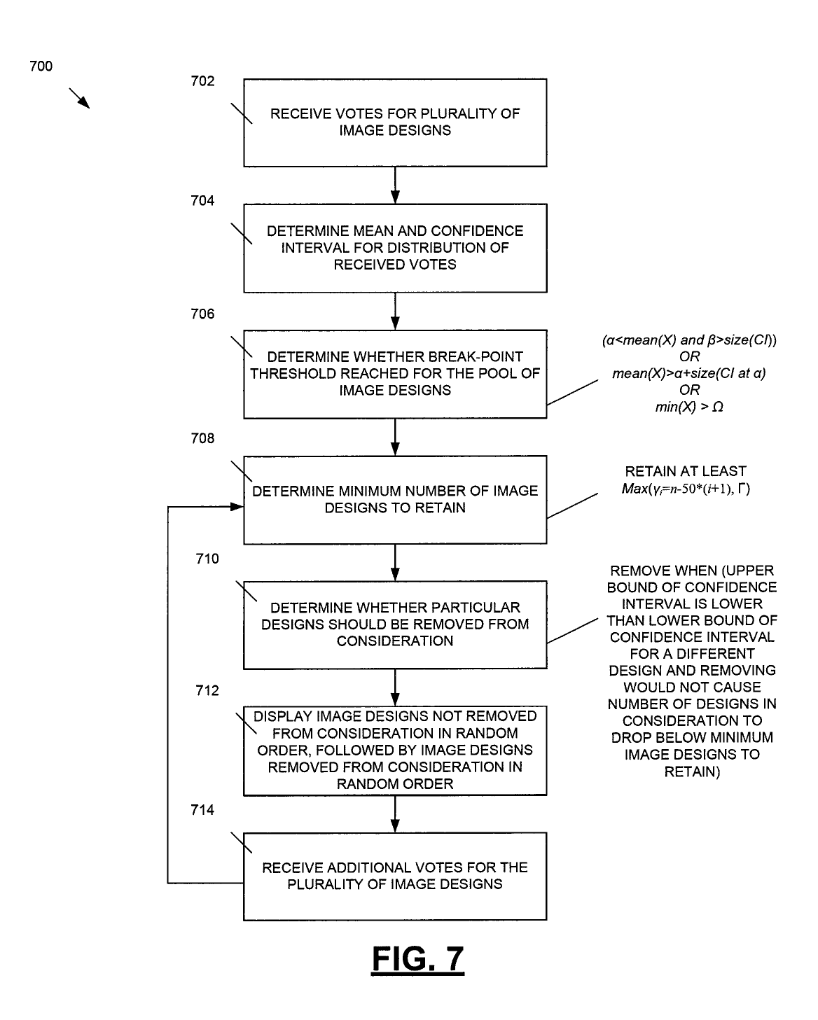

FIG. 7 is a flow diagram depicting another example method for filtering a pool of image designs. At 702, votes are received for a plurality of image designs, where the votes form a distribution across a pool of images designs. At 704, a mean and confidence interval are determined for the distribution based on the plurality of received votes. At 706, a determination is made as to whether a break-point threshold has been reached for the pool of image designs, wherein the break-point threshold is based on the mean, the confidence interval, and the minimum. At 708, a determination is made as to a minimum number of image designs to retain. At 710, a determination is made as to whether a particular design should be removed from consideration after the break-point threshold has been met. For example, the particular design may be removed from consideration based on a mean of votes for the particular design and a confidence interval for the particular design. In one example, an image design is removed from consideration when its confidence interval does not overlap the confidence interval of a design having a largest confidence interval lower bound while enforcing the minimum number of image designs to retain constraint. At 712, image designs that have not been removed from consideration are displayed. At 714, additional votes for the plurality of image designs are received. The process may revert to 708, where the number of image designs to retain may be recalculated.

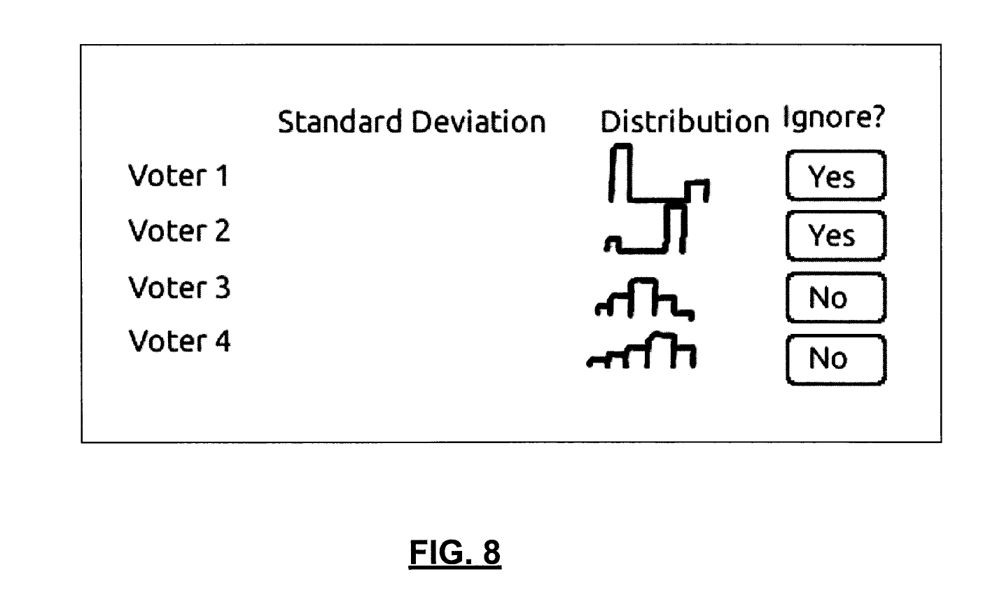

As noted above, in certain situations voters may have an incentive (e.g., a monetary incentive) to vote a certain way or to vote excessively. If one or a small group of voters' actions are significantly skewing results, then it may be desirable to ignore those voters' ratings when tabulating results. FIG. 8 depicts an example graphical user interface for ignoring certain voters. Voters are listed in rows, which may be sorted according to voting frequency. Certain statistics about each voter's behavior may be displayed for consideration. For example, the user interface may display a voter's username, rating mean, rating median, rating standard deviation, and voting distribution. Based on these statistics, a determination can be made as to whether the voter should be ignored. In the example of FIG. 8, the distribution column shows that Voter 1 and Voter 2 have odd distribution patterns, while Voter 3 and Voter 4 have more normal distributions. Voter 1 and Voter 2's behavior may imply rating their own designs very high and rating competitor designs very low. Because their voting patterns appear to be biased, it may be desirable to ignore Voter 1 and Voter 2 when calculating results.

To identify voters to display in the user interface of FIG. 8 and to determine which designs to remove from consideration, it may be desirable to classify voters as heavy voters or light voters (or other or more than two classifications). Logistic regression or another classification algorithm may be used to classify voters in such a fashion. This process includes separating a data set of voters into two or more subsets. Following such classifications, three or more confidence intervals are then calculated. For example, voters may be partitioned into three classifications: a first confidence interval with respect to the original data set, a second confidence interval with respect to heavy voters, and a third confidence interval with respect to light voters. Using information from the three or more confidences enables more precision in the ranking of confidence intervals. Such ranking can be performed as three distinct procedures. For example, the confidence interval with respect to each set of voters may be constructed independently of other sets, resulting in three different rankings of the designs. The three resulting outcomes may then be collaboratively used to assess the position of each design. Moreover, such assessment can be performed with respect to individual designs and groups of designs. Given historical data, each voter's distribution can be classified into different categories based on factors such as the number of votes cast and the voter's respective harshness.

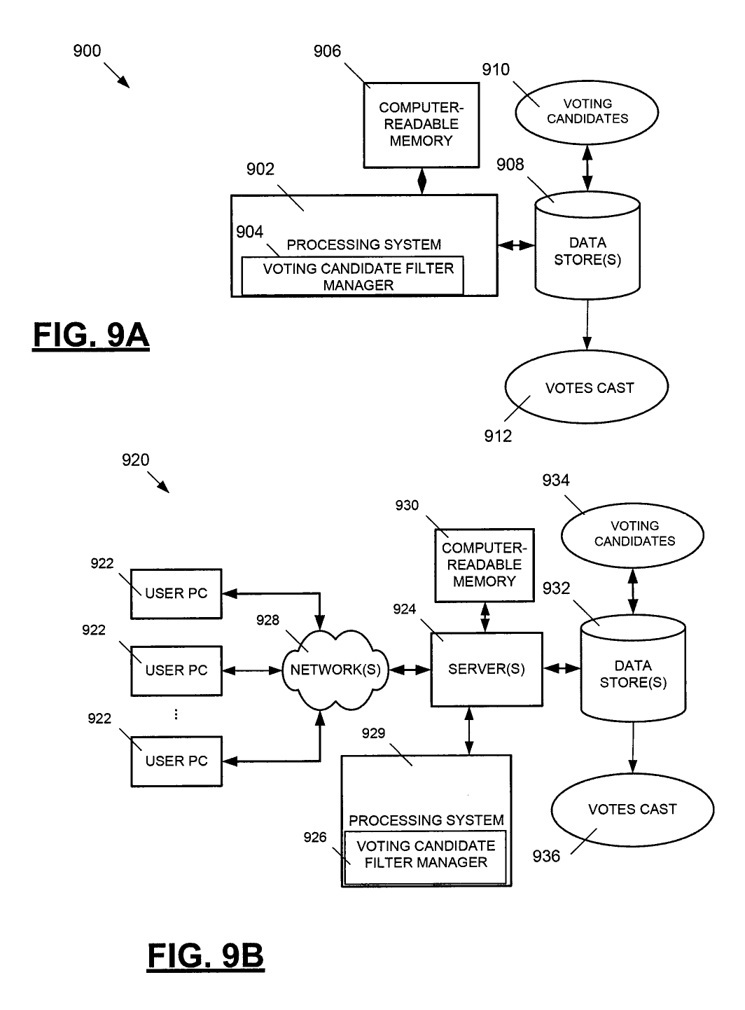

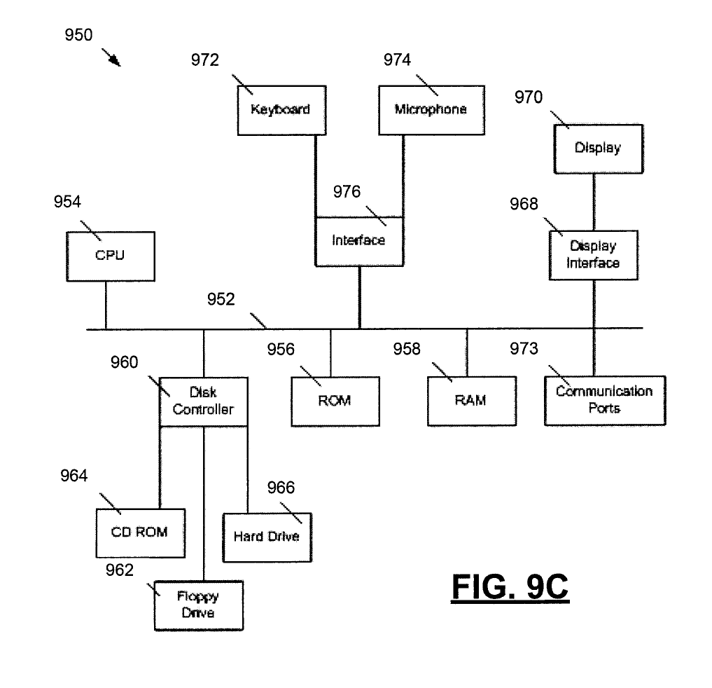

FIGS. 9A, 9B, and 9C depict example systems for use in implementing a voting candidate filter manager. For example, FIG. 9A depicts an exemplary system 900 that includes a standalone computer architecture where a processing system 902 (e.g., one or more computer processors) includes a high resolution design template generator 904 being executed on it. The processing system 902 has access to a computer-readable memory 906 in addition to one or more data stores 908. The one or more data stores 908 may include voting candidates 910 as well as votes cast 912.

FIG. 9B depicts a system 920 that includes a client server architecture. One or more user PCs 922 accesses one or more servers 924 running a voting candidate filter manager 926 on a processing system 927 via one or more networks 928. The one or more servers 924 may access a computer readable memory 930 as well as one or more data stores 932. The one or more data stores 932 may contain voting candidates 934 as well as votes cast 936.

FIG. 9C shows a block diagram of exemplary hardware for a standalone computer architecture 950, such as the architecture depicted in FIG. 9A that may be used to contain and/or implement the program instructions of system embodiments of the present invention. A bus 952 may serve as the information highway interconnecting the other illustrated components of the hardware. A processing system 954 labeled CPU (central processing unit) (e.g., one or more computer processors), may perform calculations and logic operations required to execute a program. A processor-readable storage medium, such as read only memory (ROM) 956 and random access memory (RAM) 958, may be in communication with the processing system 954 and may contain one or more programming instructions for performing the method of implementing a voting candidate filter manager. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 960 interfaces one or more optional disk drives to the system bus 952. These disk drives may be external or internal floppy disk drives such as 962, external or internal CD-ROM, CD-R, CD-RW or DVD drives such as 964, or external or internal hard drives 966. As indicated previously, these various disk drives and disk controllers are optional devices.

A display interface 968 may permit information from the bus 952 to be displayed on a display 970 in audio, graphic, or alphanumeric format. Communication with external devices may optionally occur using various communication ports 973.

In addition to the standard computer-type components, the hardware may also include data input devices, such as a keyboard 972, or other input device 974, such as a microphone, remote control, pointer, mouse and/or joystick.

As additional examples, for example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method of filtering a pool of image designs, comprising:
receiving votes for a plurality of image designs, the votes forming a distribution across the pool of image designs;
determining a mean, a confidence interval, and a minimum for the distribution based on the plurality of votes;
determining whether a break-point threshold has been reached for the pool of image designs, wherein the break-point threshold is based on the mean, the confidence interval, and the minimum;
determining whether a particular design should be removed from consideration after the break-point threshold has been met, the particular design being removed from consideration based on a mean of votes for the particular design and a confidence interval for the particular design; and
displaying image designs based on whether or not they have been removed from consideration.

2. The method of claim 1, wherein the break-point threshold requires a statistically significant number of votes be received for the pool of image designs before the particular image design is evaluated for removal from consideration.

3. The method of claim 1, wherein a time period before the break-point threshold has been reached is a data gathering time period, and wherein a time period after the break-point threshold has been reached is a data filtering time period.

4. The method of claim 1, wherein the break-point threshold is reached when:
α<mean(X) and β>size(CI),
where α is the mean for the distribution threshold and β is the confidence interval threshold, wherein mean(X) is the mean for the distribution and size(CI) is the width of the confidence interval for the distribution.

5. The method of claim 4, wherein the break-point is also reached when the minimum number of votes per design across all designs reaches a predetermined value, Ω.

6. The method of claim 1, wherein whether a particular design should be removed from consideration is based on a minimum number of image designs to retain.

7. The method of claim 6, wherein the minimum number of image designs to retain is calculated according to γᵢ=n−50×(i+1),
where γᵢ is the minimum number of image designs to retain, n is a total number of image designs in the pool of image designs, and i is a number of filtering rounds performed or a time value.

8. The method of claim 7, wherein the minimum number of image designs to retain is at least Γ image designs.

9. The method of claim 6, wherein the particular design is determined to be removed from consideration when the mean of votes for the particular design is outside of the top δᵢ image designs and the confidence interval for the particular design does not overlap a confidence interval for any other designs in the top δᵢ image designs.

10. The method of claim 1, wherein votes from particular voters are ignored.

11. The method of claim 10, further comprising:
displaying voting parameters for a particular voter; and
receiving a command to ignore votes for the particular voter.

12. The method of claim 11, wherein the voting parameters include one or more of: a user name, a vote mean, a vote median, a vote standard deviation, and a vote distribution.

13. The method of claim 11, wherein the voting parameters include a voting level parameter, wherein the voting level parameter identifies the particular voter as a heavy voter or a light voter.

14. The method of claim 11, wherein the voting parameters including a voting level parameter, wherein the voting level parameter identifies the harshness of a particular voter.

15. The method of claim 1, wherein the determination of whether a particular design should be removed from consideration includes multiple means and multiple confidence intervals calculated over subsets of voters such as heavy voters and light voters, or harsh voters and forgiving voters.

16. The method of claim 1, further comprising:
receiving additional votes for the plurality of image designs;
further filtering the image designs based on the additional votes.

17. The method of claim 1, wherein image designs that have been removed from consideration are displayed less frequently than image designs that have been removed from consideration.

18. The method of claim 1, wherein image designs that have been removed from consideration are no longer displayed.

19. A computer-implemented system for filtering a pool of image designs, comprising:
one or more data processors;
one or more computer-readable storage mediums containing instructions for commanding the one or more data processors to execute steps that include:
receiving votes for a plurality of image designs, the votes forming a distribution across the pool of image designs;
determining a mean, a confidence interval, and a minimum for the distribution based on the plurality of votes;
determining whether a break-point threshold has been reached for the pool of image designs, wherein the break-point threshold is based on the mean, the confidence interval, and the minimum;
determining whether a particular design should be removed from consideration after the break-point threshold has been met, the particular design being removed from consideration based on a mean of votes for the particular design and a confidence interval for the particular design; and
displaying image designs based on whether or not they have been removed from consideration.

20. One or more computer-readable mediums containing instructions for commanding one or more data processors to execute a method for filtering a pool of image designs, comprising:
receiving votes for a plurality of image designs, the votes forming a distribution across the pool of image designs;
determining a mean, a confidence interval, and a minimum for the distribution based on the plurality of votes;
determining whether a break-point threshold has been reached for the pool of image designs, wherein the break-point threshold is based on the mean, the confidence interval, and the minimum;
determining whether a particular design should be removed from consideration after the break-point threshold has been met, the particular design being removed from consideration based on a mean of votes for the particular design and a confidence interval for the particular design; and
displaying image designs based on whether or not they have been removed from consideration.
